(19) United States
(12) Patent Application Publication
(10) Pub. No.: US 2015/0085118 A1
(43) Pub. Date: Mar. 26, 2015

(54) METHOD AND CAMERA ASSEMBLY FOR DETECTING RAINDROPS ON A WINDSCREEN OF A VEHICLE

(71) Applicants: Samia Ahiad, Gagny (FR); Caroline Robert-Landry, Paris (FR)

(72) Inventors: Samia Ahiad, Gagny (FR); Caroline Robert-Landry, Paris (FR)

(73) Assignee: VALEO SCHALTER UND SENSOREN GMBH, Bietigheim-Bissingen (DE)

(21) Appl. No.: 14/343,429

(22) PCT Filed: Sep. 7, 2011
(86) PCT No.: PCT/EP2011/004505

§ 371 Date: Sep. 11, 2014

(51) Int. Cl. G06K 9/62; B60R 1/10

(52) U.S. Cl. CPC G06K 9/6234; B60R 1/10; B60R 2300/8053; B60R 2300/304
USPC 348/148; 382/195

(57) ABSTRACT

The invention concerns a method for detecting raindrops on a windscreen of a vehicle, in which an image of at least an area of the windscreen is captured, wherein at least one object its extracted from the captured image, and wherein ambient light conditions are determined (S12). At least one of at least two ways of object extraction (S14, S18) is performed in dependence on the ambient light conditions. Moreover, the invention concerns a camera assembly for detecting raindrops on a windscreen of a vehicle.

The invention relates to a method for detecting raindrops on a windscreen of a vehicle, in which an image of at least an area of the windscreen is captured by a camera. At least one object is extracted from the captured image, and ambient light conditions are determined. Moreover, the invention relates to a camera assembly for detecting raindrops on a windscreen of a vehicle.

For motor vehicles, several driving assistance systems are known, which use images captured by a single or by several cameras. The images obtained can be processed to allow a display on screens, for example at the dashboard, or they may be projected on the windscreen, in particular to alert the driver in case of danger or simply to improve his visibility. The images can also be utilized to detect raindrops or fog on the windscreen of the vehicle. Such raindrop or fog detection can participate in the automatic triggering of a functional units of the vehicle. For example the driver can be alerted, a braking assistance system can be activated, windscreen wipers can be turned on and/or headlights can be switched on, if rain is detected.

U.S. Pat. No. 6,806,485 B2 describes an optical moisture detector which is able to determine an absolute value corresponding to ambient light conditions. The detector includes an optical moisture sensor which senses the presence of moisture on a moisture collecting surface.

EP 1 025 702 B1 describes a rain sensor system including an illumination detector such as a CMOS imaging array or a CCD imaging array. Depending on the level of ambient light a control unit switches on an illumination source, when the ambient light on the windscreen is too low to illuminate rain drops which are present on the windscreen.

Methods and camera assemblies known from the state of the art have encountered difficulties in reliably detecting raindrops on a windscreen.

It is therefore the object of the present invention to create a particularly reliable method and camera assembly for detecting raindrops on a windscreen.

This object is met by a method with the features of claim 1 and by a camera assembly with the features of claim 9. Advantageous embodiments with convenient further developments of the invention are indicated in the dependent claims.

According to the invention, in a method for detecting raindrops on a windscreen an image of at least an area of the windscreen is captured by a camera. At least one object is extracted from the captured image and ambient light conditions are determined, wherein at least one of at least two ways of object extraction is performed in dependence on the ambient light conditions. This is based on the finding, that a raindrop on the windscreen can have several appearances depending on lighting conditions. Consequently, a rain detection algorithm which considers the ambient light conditions is chosen to utilize—among different ways of object extraction—the at least one way which is particularly adapted to the determined lighting conditions. This makes the method particularly reliable and also provides for fast and efficient raindrop detection.

In an advantageous embodiment of the invention at nocturnal or tunnel ambient light conditions objects are extracted from the captured image by detecting objects of which a grey level is lower than a predetermined threshold value. At dark night conditions or in a dark tunnel a raindrop on the windscreen appears darker in the captured image of the area of the windscreen than the already dark background of the image. In order to determine whether such dark night lighting conditions are present a number and/or a brightness of light sources can be evaluated, for example by determining whether the number and/or the brightness of light sources is below a predetermined threshold value. If in such dark night lighting conditions only objects with a low grey level are extracted from the image, the raindrop detection can be performed fast, reliably and efficiently.

In a further advantageous embodiment of the invention at nocturnal or tunnel ambient light conditions with a number and/or a brightness of light sources above a predetermined threshold value, objects are extracted from the captured image by detecting objects of which a grey level is higher than a predetermined threshold value. This is based on the finding that by night a raindrop in the captured image appears brighter than the relatively dark surroundings of the raindrop, if there are near and powerful light sources. Therefore, by clear night or bright tunnel lighting conditions it is sufficient for the detection of objects which may be raindrops to look for objects with a relatively high grey level. The way of object extraction is therefore adapted to such clear night lighting conditions for a reliable and fast raindrop detection.

It has further turned out to be advantageous, when at daylight ambient light conditions objects are extracted from the captured image by detecting an object's dark part and an object's bright part, wherein the dark part and the bright part of the object are merged. The dark part can be detected by comparing its grey level with a predetermined threshold value and the bright part by comparing its grey level with a with another, higher predetermined threshold value. By clear day a raindrop on the windscreen appears in the captured image as an object with a luminous part and a dark part. Therefore, the extraction of the object potentially representing a raindrop in the captured image can be performed by bright and dark object extraction and subsequent merging of contrasted zones. In this fusion of zones photometric and geometric constraints are considered. By merging the dark and bright parts of objects, the particular appearance of raindrops on the windscreen as present in the captured image at daylight conditions is appropriately considered.

In a further preferred embodiment of the invention the ambient light conditions are determined by means of the camera. Thus, no other sensor capable of estimating the ambient light conditions needs to be provided. The information on the ambient light conditions is rather obtained by processing the captured image. The detection of raindrops on the windscreen can thus be performed by a very compact camera assembly.

A very accurate estimation of ambient light conditions can be obtained, if the latter are determined quantitatively. This also allows for a very precise differentiation between different lighting conditions. On the other hand the ambient light conditions can be determined qualitatively. This makes it possible to use a relatively simple camera. Alternatively an electronic device such as a comparator and can be utilized in order to indicate whether there are daylight, nocturnal or twilight ambient light conditions. This simplifies the determination of the lighting conditions to be taken into account for the choice of the appropriate way of object extraction.

In still a further advantageous embodiment of the invention the objects are extracted using a segmentation of the captured image by region and/or segmentation of the captured image by edges. Segmentation by region can be based on morphological operations, or level set methods can be used as well as the growing up of regions or segments. For edge detection an active contour model, that is so-called snakes, can be utilized. These methods for object extraction are very efficient in analyzing the captured image.

Finally, it has turned out to be advantageous to classify the extracted objects in order to detect raindrops. A score or confidence level can be assigned to each extracted object in order to determine whether the extracted object is a raindrop or not. Thus an appropriate action can be taken, which takes into account the detected raindrops.

The camera assembly according to the invention, which is configured to detect raindrops on a windscreen of a vehicle comprises a camera for capturing an image of at least an area of the windscreen, processing means configured to extract at least one object from the captured image and means for determining ambient light conditions. The processing means are configured to perform at least one of at least two ways of object extraction in dependence on the ambient light conditions. This allows the processing means to reliably detect raindrops on the windscreen, as the way of object extraction is chosen appropriately with respect to the ambient light conditions.

The camera preferably is sensitive in the spectral range of wavelengths for which the human eye is sensitive as well.

The preferred embodiments presented with respect to the method for detecting raindrops and the advantages thereof correspondingly apply to the camera assembly according to the invention and vice versa.

All of the features and feature combinations mentioned in the description above as well the features and feature combinations mentioned below in the description of the figures and/or shown in the figures alone are usable not only in the respectively specified combination, but also in other combinations or else alone without departing from the scope of the invention.

Further advantages, features and details of the invention are apparent from the claims, the following description of preferred embodiments as well as from the drawings. Therein show:

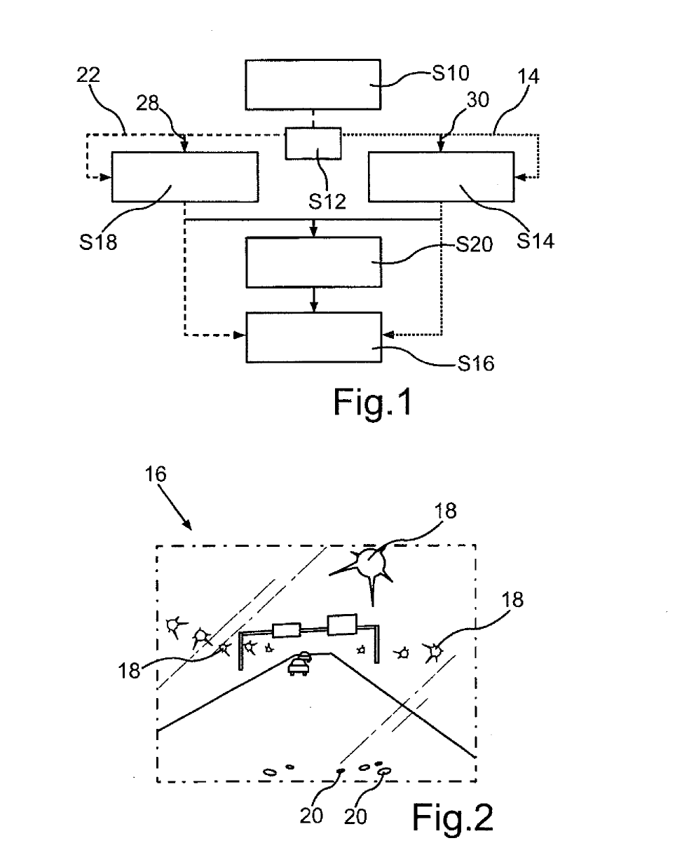

FIG. 1 a flow chart for illustrating object extraction methods chosen in accordance with ambient light conditions;

FIG. 2 a clear night image with comparatively many and bright light sources and raindrops that appear brighter than their surroundings in the image captured by a camera;

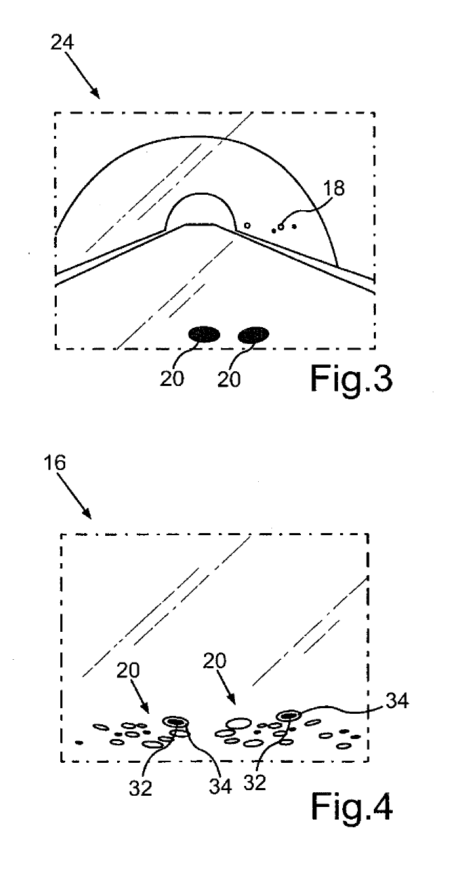

FIG. 3 an image captured by the camera at dark night ambient light conditions, wherein raindrops appear as regions darker than their background;

FIG. 4 the appearance of raindrops on a windscreen in an image captured at daylight conditions;

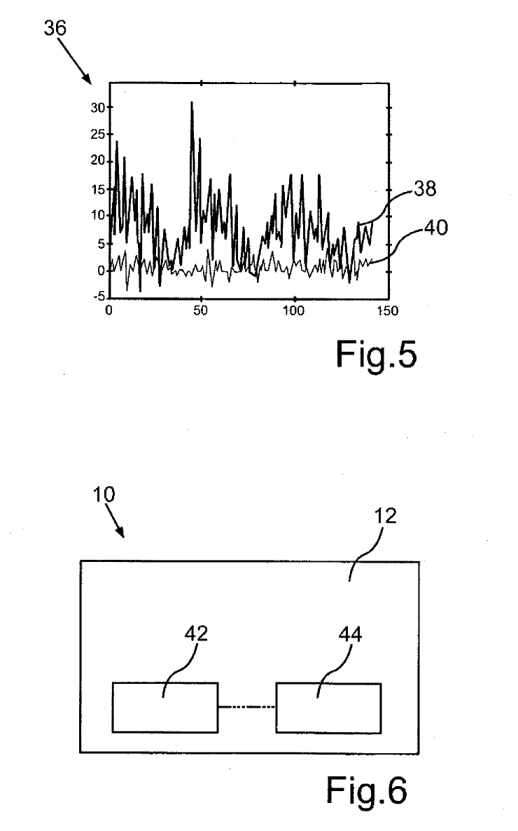

FIG. 5 an example object classification which is based one the utilization of a separating descriptor by a processing means of a camera assembly; and

FIG. 6 very schematically the camera assembly configured to perform the detection of raindrops on a windscreen of a vehicle.

A camera assembly 10 (see FIG. 6) for detecting raindrops on a windscreen of a vehicle comprises a camera 12 mounted onboard the vehicle. The camera 12 which may include a CMOS or a CCD image sensor is configured to view the windscreen of the vehicle and is installed inside a cabin of the vehicle. The windscreen can be wiped with the aid of wiperblades in case the camera assembly 10 detects raindrops on the windscreen. The camera 12 captures images of the windscreen, and through image processing it is determined whether objects on the windscreen are raindrops or not.

For the detection of raindrops on the windscreen ambient light conditions are taken into consideration in order to chose the appropriate way of object extraction. In FIG. 1 image processing steps are visualized, which are undertaken for raindrop detection.

In an image pre-processing step S10 the image captured by the camera 12 is prepared. For example the region of interest is defined and noise filters are utilized. In a next step S12 ambient light conditions are determined. Depending on the ambient light conditions, different ways of object extraction are performed when the captured image is processed.

A first arrow 14 indicates that upon determination of ambient light conditions which correspond to a clear night in a step S14 objects with a high grey level are extracted. An exemplary image 16 which shows such clear night conditions is represented in FIG. 2. Such clear night conditions refer to nocturnal ambient light conditions with a relatively large number or relatively near light sources 18. These light sources 18, such as streetlights, headlights of oncoming traffic, taillights of traffic in front of the vehicle and the like, result in an appearance of raindrops 20 within the image 16, which are brighter than their surroundings. Therefore it is sufficient in step S14 to extract objects with a relatively high grey level in order to define objects which will later, namely in a step S16 be classified as raindrops or non-drops.

If in step S12 it is determined that the ambient light conditions correspond to a dark night another way of object extraction is applied to the image captured by the camera 12. As indicated by an arrow 22 in FIG. 1 in a step S18 objects are extracted from an image 24 (see FIG. 3) captured by the camera 12, wherein the objects have a relatively low grey level. This is because by a dark night with only limited light sources 18 (see FIG. 3) raindrops 20 within an image 24 captured by the camera 12 appear darker than their background. It is therefore sufficient to perform extraction of objects with very low grey level in order to find objects that may correspond to raindrops 20 on the windscreen. These dark objects are later on classified (see step S16).

If the ambient light determination in step S12 yields that an image 26 (see FIG. 4) has been captured by the camera 12 during daylight, yet another way of object extraction is performed. As indicated by arrows 28 and 30 in FIG. 1, at daylight conditions objects which have a low grey level and objects which have a high grey level are extracted from the image 26 (see FIG. 4). This is due to the fact that during daylight raindrops 20 on the windscreen appear as regions with a dark part 32 and a bright part 34 in the image 26. The dark part 32 can in particular be surrounded by the bright part 34 (see FIG. 4). After the dark part 32 and the bright part 34 of the object potentially corresponding to a raindrop 20 has been extracted, the contrasted zones are merged. This step S20, in which the fusion of extracted objects takes place, is only performed when there are daylight conditions (see FIG. 1). The merging of bright and dark components to build raindrops 20 (see FIG. 4) takes into account geometric and photometric constraints. The objects resulting from the fusion (see step S20) are then classified in step S16.

This object classification undertaken in step S16 can be based on a number of descriptors that may describe an object's shape, intensity, texture and/or context. Shape descriptors can consider a ratio of height and width of the object, the object perimeter, object area, the circularity of the object, and the like. Intensity descriptors may classify the object according to its maximum intensity, its minimum intensity, or a mean intensity. Also, the mean intensity of red components within the object can be taken into consideration for the object's classification. Texture descriptors can be used to classify the object according to moment, uniformity, rugosity, cumulated gradient, and the like. Also, a histogram of oriented gradients can be established in order to classify the objects.

FIG. 5 shows a graph 36 with two curves 38, 40. In this graph 36 the cumulated local gradients are visualized. Curve 38 allows to classify objects as true raindrops 20, whereas curve 40 is indicative of objects to be classified as false drops or non-drops.

In the object classification (see step S16 in FIG. 1) performed during the image processing also context descriptors can be utilized. Such context descriptors may take into consideration the vehicle speed as well as quantitative or qualitative lighting conditions. In order to quantify the lighting conditions, the global intensity mean in a detection region of interest can be determined, or the standard deviation of the intensity in the detection region of interest, and/or the ambient light may be indicated in lux.

Qualitative lighting condition determination may distinguish between daylight, twilight, night without light source, and night with light source. The night without light source will lead to performing the object extraction according to the arrow 22 in FIG. 1, that is the dark night ambient light condition, whereas the night with light source determination leads to the performance of object extraction according to the arrow 14 in FIG. 1.

In the object classification a score or confidence level value is assigned to each extracted object. In elaborating the score or the confidence level, the descriptors and context of each object are taken into consideration. The object classification can be performed by a supervised learning machine, for example a support vector machine.

FIG. 6 shows schematically the camera assembly 10 comprising the camera 12 as well as processing means 42 which are configured to extract the objects from the captured images 16, 24, 26 (see FIG. 2 to FIG. 4) while taking into consideration the ambient light conditions as determined by means 44 of the camera assembly 10. The means 44 can be software utilized to process the image 16, 24, 26 captured by the camera 12. Alternatively or additionally a measuring device capable of determining the ambient light conditions can be utilized, which is not part of the camera 12. The processing means 42 may also be separate from the camera 12.

As the raindrop detection software obtains information on the ambient light conditions, the extraction function to be utilized with the specific appearance of drops in the captured images 16, 24, 26 can be adapted to these lighting conditions, for example daylight, tunnel, night with light sources, or night without any additional light sources. In this way the extraction of objects potentially corresponding to raindrops 20 on the windshield performed by the camera 12 is directly correlated to the ambient light conditions.

1. A method for detecting raindrops on a windscreen of a vehicle, in which an image of at least an area of the windscreen is captured by a camera, wherein at least one object is extracted from the captured image, and wherein ambient light conditions are determined, wherein at least one of at least two ways of object extraction is performed in dependence on the ambient light conditions.

2. The method according to claim 1, wherein at nocturnal or tunnel ambient light conditions with a number and/or a brightness of light sources below a predetermined threshold value, objects are extracted from the captured image by detecting objects a grey level of which is lower than a predetermined threshold value.

3. The method according to claim 1, wherein at nocturnal or tunnel ambient light conditions with a number and/or a brightness of light sources above a predetermined threshold value, objects are extracted from the captured image by detecting objects a grey level of which is higher than a predetermined threshold value.

4. The method according to claim 1, wherein at daylight ambient light conditions objects are extracted from the captured image by:
detecting an object's dark part a grey level of which is lower than a predetermined threshold value; and
detecting an object's bright part a grey level of which is higher than a predetermined threshold value, wherein
the dark part and the bright part of the object are merged.

5. The method according to claim 1, wherein the ambient light conditions are determined by means of the camera.

6. The method according to claim 1, wherein the ambient light conditions are determined quantitatively or qualitatively.

7. The method according to claim 1, wherein the objects are extracted using a segmentation of the captured image by region and/or a segmentation of the captured image by edges.

8. The method according to claim 1, wherein the extracted objects are classified in order to detect raindrops.

9. A camera assembly for detecting raindrops on a windscreen of a vehicle, comprising;
a camera for capturing an image of at least an area of the windscreen, processing means configured to extract at least one object from the captured image, and means for determining ambient light conditions,
wherein the processing means are configured to perform at least one of at least two ways of object extraction in dependence on the ambient light conditions.
